(19) United States
(12) Patent Application Publication
(10) Pub. No.: US 2008/0046406 A1
(43) Pub. Date: Feb. 21, 2008

(54) Audio and video thumbnails

(75) Inventors: Frank T.B. Seide, Beijing (CN); Lie Lu, Beijing (CN); Hong-Qiao Li, Beijing (CN); Cheng Ge, Shanghai (CN)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/504,549

(22) Filed: Aug. 15, 2006

(51) Int. Cl. G06F 17/30

(52) U.S. Cl. 707/3

(57) ABSTRACT

A new way of providing search results that include audio/video thumbnails for searches of audio and video content is disclosed. An audio/video thumbnail includes one or more audio/video segments retrieved from within the content of audio/video files selected as relevant to a search or other user input. For an audio/video thumbnail of more than one segment, the audio/video segments from an individual audio/video file responsive to the search are concatenated into a multi-segment audio/video thumbnail. The audio/video segments provide enough information to be indicative of the nature of the audio/video file from which each of the audio/video thumbnails is retrieved, while also fast enough that a user can scan through a series of audio/video thumbnails relatively quickly. A user can then watch or listen to the series of audio/video thumbnails, which provide a powerful indication of the full content of the search results, and make searching for audio/video content easier and more effective, across a broad range of computing devices.

### BACKGROUND

Online audio and video content has become very popular, as have searches for such audio/video content. Searches typically provide indications of the search results in the form of a link with a few snippets of text showing the search query keywords in context as found in the search results, and perhaps a thumbnail image as found in the search results. Text searches for audio/video content present additional challenges. For one thing, there are limits to the effectiveness of a few samples of text or a thumbnail image in indicating to the user the relevance of the audio/video content to the user's intended search. Text and image thumbnail search results for audio/video content also present additional challenges in the increasingly used mobile computing devices. For example, these devices may have very small monitors or displays. This makes it relatively difficult for a user to quickly comprehend and interact with the displayed results.

The discussion above is merely provided for general background information and is not intended to be used as an aid in determining the scope of the claimed subject matter.

### SUMMARY

A new way of providing search results that include audio/video thumbnails for searches of audio and video content is disclosed. An audio/video thumbnail includes one or more audio/video segments retrieved from within the content of audio/video files selected as relevant to a search or other user input. For an audio/video thumbnail of more than one segment, the audio/video segments from an individual audio/video file responsive to the search are concatenated into a multi-segment audio/video thumbnail. The audio/video segments provide enough information to be indicative of the nature of the audio/video file from which each of the audio/video thumbnails is retrieved, while also being fast enough that a user can scan through a series of audio/video thumbnails relatively quickly. A user can then watch or listen to the series of audio/video thumbnails, which provide a powerful indication of the full content of the search results, and make searching for audio/video content easier and more effective, across a broad range of computing devices.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 depicts an audio/video thumbnail search result system, according to an illustrative embodiment.

FIG. 2 depicts an audio/video thumbnail search result system, according to another illustrative embodiment.

FIG. 3 depicts a flowchart of a method for audio/video thumbnail search results, according to an illustrative embodiment.

FIG. 4 depicts a computing device used for an audio/video thumbnail search result system, according to another illustrative embodiment.

FIG. 5 depicts a data flow module block diagram of an audio/video file summarization system 500, according to an illustrative embodiment.

FIG. 6 depicts a flowchart of a sentence segmentation process, according to an illustrative embodiment.

FIG. 7 depicts a computing device used for an audio/video thumbnail search result system, according to another illustrative embodiment.

FIG. 8 depicts a block diagram of a computing environment, according to an illustrative embodiment.

FIG. 9 depicts a block diagram of a general mobile computing environment, according to an illustrative embodiment.

### DETAILED DESCRIPTION

A new way of providing search results for searches of audio and video content (collectively referred to as audio/video content), and more generally of providing content relevant to user inputs, is disclosed. Instead of responding to a search for audio/video content only with thumbnail images or snippets of text indicative of the content of the search results, audio/video thumbnails are provided. An audio/video thumbnail includes one or more audio/video segments retrieved from within the content of the full audio/video files selected as relevant results to the search. For an audio/video thumbnail of more than one segment, the audio/video segments are concatenated into a continuous, multi-segment audio/video thumbnail.

In one illustrative embodiment, for example, the audio/video segments are typically short, five to fifteen second segments including one or a few sentences of spoken word language, and anywhere from one to five audio/video segments are selected or isolated out from each of a set of the highest-ranked audio/video files in terms of relevance to the search query. A search query may include one or more search terms. In this embodiment, the user is able to watch or listen to highlights of a series of audio/video search results in a fraction of a minute per audio/video thumbnail containing those highlights. Each thumbnail is from its respective audio/video file in the search results, thereby providing the user with an effective indication of what content to expect from the full audio/video file. This allows the user to decide, while watching or listening to each audio/video thumbnail in sequence, whether the user would like to begin watching or listening to the full audio/video file, or keep going to the next audio/video thumbnail.

The audio/video segments are selected from among the full content of the audio/video files in a variety of ways, with the general object of providing enough information to be indicative of the nature of the content in the particular audio/video file from which each of the audio/video thumbnails is retrieved, while also being fast enough that a user can scan through a series of audio/video thumbnails relatively quickly to facilitate the user finding particular audio/video thumbnails that particularly interest her and appear to indicate source content that is particularly relevant to the search query used, in the present illustrative embodiment. A user can then watch or listen to the series of audio/video thumbnails. This provides a more powerful indication of the full content of the search results than is possible with the thumbnail images and/or snippets of text that are traditionally provided as indicators of search results.

Embodiments of an audio/video thumbnail search result system can be implemented in a variety of ways. The following descriptions are of illustrative embodiments, and constitute examples of features in those illustrative embodiments, though other embodiments are not limited to the particular illustrative features described.

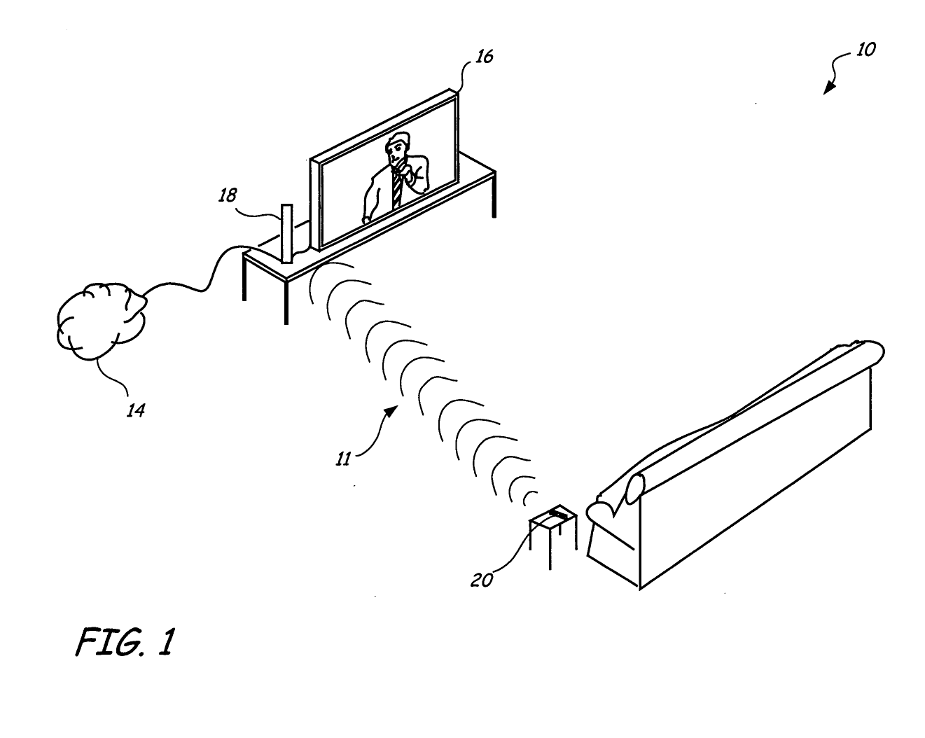

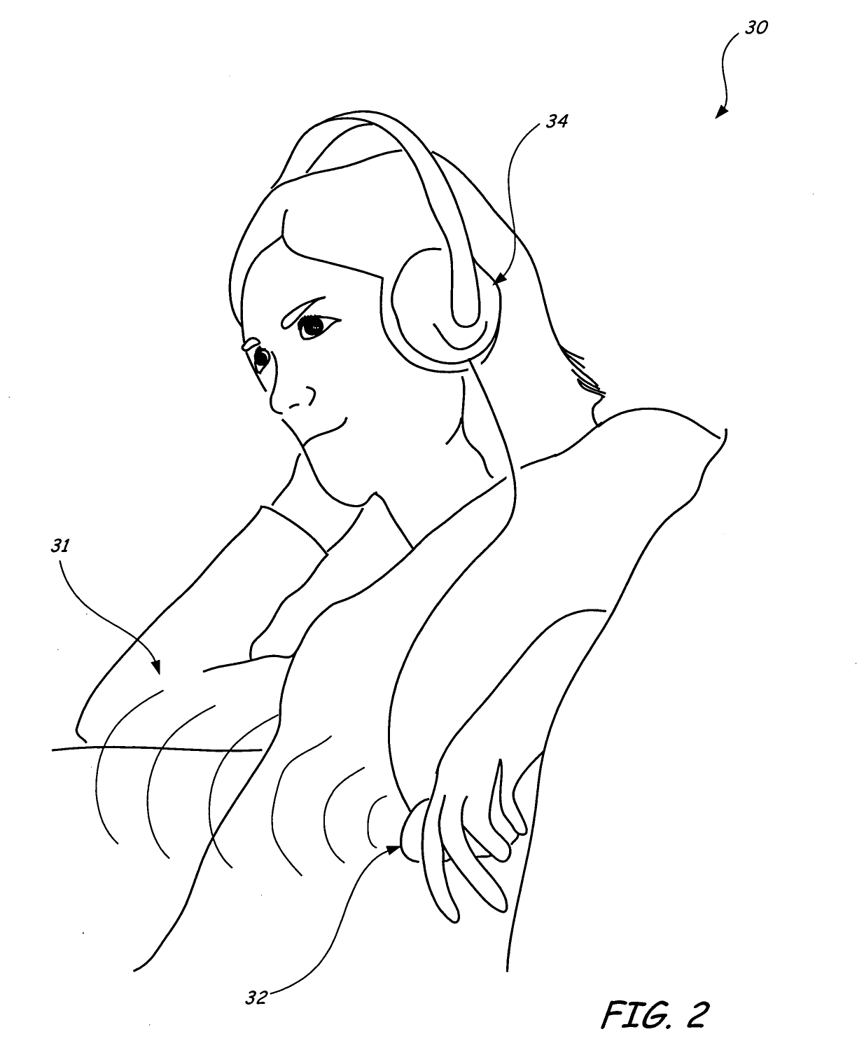

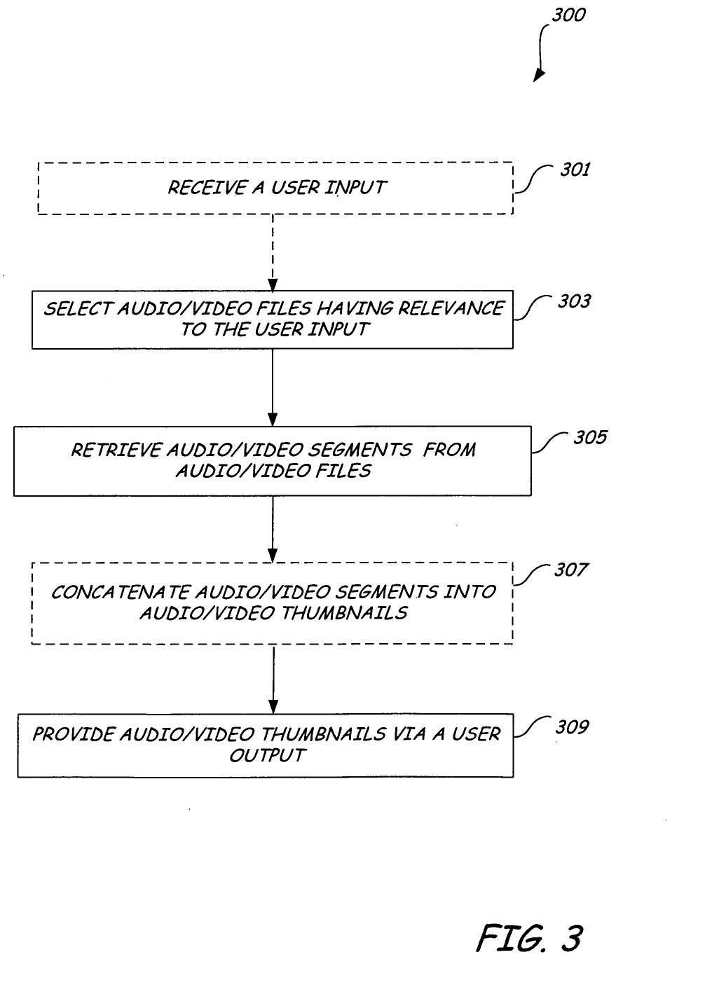

FIGS. 1-3 introduce a few illustrative embodiments; FIGS. 1 and 2 depict physical embodiments, while FIG. 3 depicts a flowchart for a method.

FIG. 1 depicts an audio/video thumbnail search result system 10 with a mobile computing device 20, according to an illustrative embodiment. This depiction and the description accompanying it provide one illustrative example from among a broad variety of different embodiments intended for an audio/video thumbnail search result system. Accordingly, none of the particular details in the following description are intended to imply any limitations on other embodiments.

In this illustrative embodiment, audio/video thumbnail search result system 10 provides a search for audio and video content that can return audio/video thumbnail search results indicating the full content search results. Audio/video thumbnail search result system 10 may be implemented in part by mobile computing device 20, depicted resting on an end table. Mobile computing device 20 is in communicative connection to monitor 16, an auxiliary user output device, and to network 14, such as the Internet, through wireless signals 11 communicated between mobile computing device 20 and wireless hub 18, in this illustrative example. Mobile computing device 20 may provide audio/video content via its own monitor and/or speakers in different embodiments, and may also provide user output via monitor 16 in a mode of usage as depicted in FIG. 1.

FIG. 2 depicts an audio/video thumbnail search result system 30 with a mobile computing device 32, according to an illustrative embodiment. In this illustrative embodiment, audio/video thumbnail search result system 30 also provides a network search for audio and video content that can return audio/video thumbnail search results indicating the full content search results. Audio/video thumbnail search result system 30 may be implemented in part by mobile computing device 32, depicted being held by a seated user. Mobile computing device 32 is in communicative connection to headphones 34, a user output device, and to a network, such as the Internet, through wireless signals 31 communicated between mobile computing device 32 and a wireless hub (not depicted in FIG. 2), in this illustrative example. Mobile computing device 32 may provide audio/video content via its own monitor and/or speakers in different embodiments, and may also provide user output via headphones 34 in a mode of usage as depicted in FIG. 2. Other embodiments may include a desktop, laptop, notebook, mobile phone, PDA, or other computing device, for example.

Audio/video thumbnail search result systems 10, 30 are able to play video or audio content from any of a variety of sources of audio and/or video content, including an RSS feed, a podcast, a download client, an Internet radio or television show, accessible from the Internet, or another network, such as a local area network, a wide area network, or a metropolitan area network, for example. While the specific example of the Internet as a network source is used often in this description, those skilled in the art will recognize that various embodiments are contemplated to be applied equally to any other type of network. Non-network sources may include a broadcast television signal, a cable television signal, an on-demand cable video signal, a local video medium such as a DVD or videocassette, a satellite video signal, a broadcast radio signal, a cable radio signal, a local audio medium such as a CD, a hard drive, or flash memory, or a satellite radio signal, for example. Additional network sources and non-network sources may also be used in various embodiments.

FIG. 3 depicts a flowchart of a method 300 for audio/video thumbnail search results, according to an illustrative embodiment of the function of audio/video thumbnail search result systems 10 and 30 of FIGS. 1 and 2. Different method embodiments may use additional steps, and may omit one or more of the steps depicted in the illustrative embodiment of method 300 in FIG. 3.

Method 300 includes step 301, to receive a user input, such as a search query for a search of audio/video files, comprising audio and/or video content, or a similar content search or inputs under an automatic recommendation protocol, for example; step 303, to select audio/video files that include audio and/or video content relevant to the user input; step 305, to retrieve or isolate one or more audio/video segments from each of one or more of the audio/video files; step 307, to concatenate the audio/video segments from each of the audio/video files from which the audio/video segments were retrieved into an audio/video thumbnail corresponding to the respective audio/video files; and step 309, of playing or otherwise providing the audio/video segments, in the form of the audio/video thumbnails, via a user output, as results for the search. These steps are further explained as follows.

The user input may take any of several forms. One form includes a query search, in which the user enters a search query including one or more search terms and engages a search for that query. In this case, audio/video files may be selected for having relevance to the search query.

In another illustrative form, the user input may take the form of a similar content search based on previously accessed content. For example, the user may first execute a query search, or simply access a Web page or a prior audio/video file, and then may select an icon that says “similar content”, or “videos that others like you enjoyed”, or something to that effect. Audio/video files may then be selected and ranked based on relevance or similarity of the audio/video files to the query search, Web page, audio/video file, or other content that the user previously accessed, and on which the similar content search is based.

In yet another illustrative form, an automatic recommendation mode may be engaged, and the audio/video files may be selected and ranked based on relevance of the audio/video files to the user input, and proactively provided as an automatic recommendation to the user. The relevance of the audio/video files to the user input may be based on one or more criteria such as the prior history of input by the user, the prior selections of users with general preferences similar to those of the user, and the general popularity of the audio/video files, among other potential criteria.

Any type of user input capable of serving as a basis for relevance for selecting content can be considered an implicit search, and where a search is discussed, any type of implicit search can be substituted, in various embodiments.

Once the audio/video segments are being provided, either as their own thumbnails or concatenated into multi-segment thumbnails, a user is able to watch or listen to the audio/video thumbnails to gain indications of the content in the full audio/video files responsive to the search. A user-selectable option is also provided to play a larger portion of the audio and/or video content, such as the full audio/video file corresponding to the audio/video thumbnail comprising segments isolated out of that full audio/video file.

Audio/video files are referred to in this description as a general-purpose term to indicate any type of audio and/or video files, which may include video files with audio such as video podcasts, television shows, movies, graphics animation files, videos, and so forth; video-only files, such as some graphics animation files, for example; audio-only files, such as music or audio-only podcasts, for example; collections of the above types of audio and/or video files; and other types of media files. While reference is made in this description to audio/video search results, audio/video content, audio/video files, audio/video segments, audio/video thumbnails, and so forth, those skilled in the art will appreciate that any of these references to audio/video may refer to audio only, to video only, to a combination of audio and video, or to anything else that comprises at least one of an audio or a video characteristic; and that “audio/video” is used to refer to this broad variety of subject matter for the sake of a convenient label for that variety.

Additional search result indicators may be provided in parallel with the audio/video thumbnails. Segments of relevant text, and/or relevant image thumbnails, associated with the audio/video files, may also be shown in tandem with the audio/video segments. The thumbnail images may come from metadata accompanying the audio/video files, or from still images from the audio/video files, for example. Likewise, the text segments may come from metadata, or from a transcript generated by automatic speech recognition, or from closed captions associated with the audio/video files, for example. In one illustrative embodiment, one or more of the audio/video thumbnails are provided together with text samples and thumbnail images from the respective audio/video files, providing a substantial variety of information about the respective search result at the same time. A user may also be provided the option to start a selected video file at the beginning, or to start playback from one of the clips shown in the audio/video thumbnail.

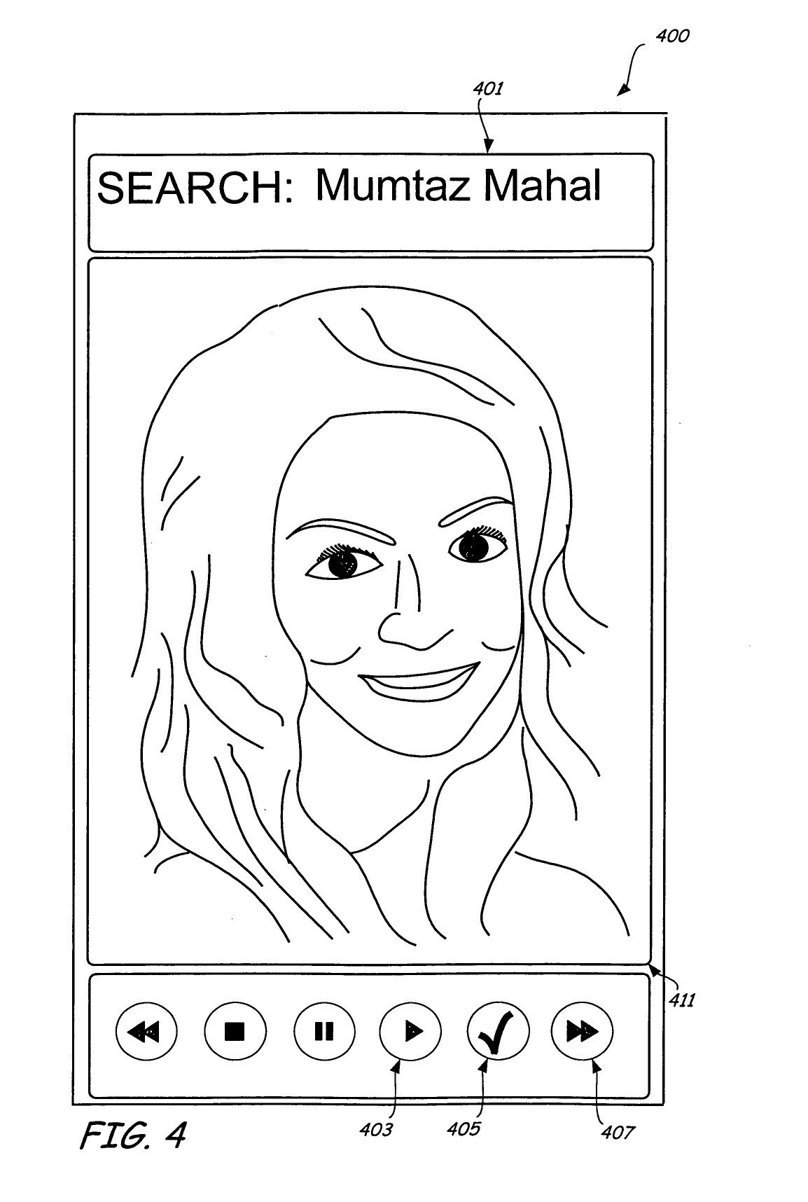

FIG. 4 depicts a close-up image of a computing device 400 implementing an audio/video thumbnail search result system, according to another illustrative embodiment. Computing device 400 includes a user input screen 401, such as a stylus screen with handwriting recognition, for example. Other user input modes could be used in other embodiments for entering search queries, such as text or spoken word, for example.

In FIG. 4, a user has entered a search instruction with a search query on user input screen 401, and hit key 403 to perform the search. Computing device 400 then selected a set of relevant audio/video files in response to the search, retrieved audio/video segments from each of the audio/video files and concatenated them into audio/video thumbnails. As depicted in FIG. 4, computing device 400 is now playing the audio/video segments, as concatenated in the audio/video thumbnails, via the user output monitor 411, as results for the search.

When a full audio/video file is selected, it may be accompanied by a timeline (not depicted in FIG. 4) in one illustrative embodiment, as is commonly done for playback of video files. One useful difference may be that the timeline may include markers showing where in the progress of the video file each of the audio/video segments included in the audio/video thumbnail for that audio/video file occur. A user can then skip forward or skip back to the positions where the audio/video segments originated, to see quickly more of the immediate context of those segments, if the user so desires.

For the case of audio-only segments and thumbnails, the monitor 411, or a monitor on other embodiments, may still provide valuable additional information indicative of the content of the corresponding audio files, such as transcript clips, metadata descriptive text, or other segments of text, or image thumbnails, to accompany the audio thumbnail. During playback of an audio-only file, the monitor 411 may be used to display a running transcript, or allowed to go blank or run a screensaver or ambient animation or visualizer based on the audio output. The monitor may also be put to use with other applications not involved in the audio file while the audio playback is being provided, in various illustrative implementations.

Any of a wide variety of search techniques may be used, in isolation or in combination, for the search to select the audio/video files most relevant to the search and to present them via the user output in an order ranked by how relevant they are to the search. For example, the audio/video files may be selected and ranked based on relevance of the audio/video files to one or more keywords in the search query on which the search is based, such as the keywords appearing in the audio/video file, according to one embodiment. The highest weighted search results, based on any of a variety of weighting methods intended to rank the audio/video files in order from those most relevant to the search query, may be displayed first. The search results may be displayed in list form; or, in embodiments with a very small monitor or no monitor, the audio/video thumbnails may be played without any text listing of a significant set of the audio/video files identified as the search results.

The audio/video segments retrieved may also be selected from the audio/video files based on relevance of the audio/video segments to one or more keywords in a search query on which the search is based. So, after the audio/visual files have been selected for relevance to the search, the audio/visual segments are themselves also selected for relevance to the search. This may be done by including, in a much shorter clip, some or all of the same material that was recognized as making the audio/video file relevant to the search. It may also be included in the audio/video thumbnail which the user evaluates to ascertain whether she is interested in beginning to watch or listen to the entire audio/video file.

The relevance of the audio/video segments to the search query may be evaluated using automatic speech recognition, to compare vocalized words in the audio/video segments with words in the search query. Vocalized words may include spoken words, musical vocals, or any other kind of vocalization, in different embodiments.

For example, in one illustrative embodiment, audio/video files are indexed in preparation for later searches, and automatic speech recognition is used to segment the sentences in the audio/video files and index the words used in each of the sentences. Then, when a search is performed, the text indexes of the audio/video files are evaluated for relevance to the search query, and any individual sentences found to be relevant can be retrieved, by reference to the audio/video segments corresponding to the sentences from which the relevant text was originally obtained. Those individual sentence segments are provided as audio/video thumbnails or are concatenated into audio/video thumbnails. In this embodiment, the particular audio/video segments retrieved from the relevant audio/video files are themselves dependent on the query or search query.

In other embodiments, however, segments may be pre-selected from the audio/video files as likely to be particularly, inherently indicative of their respective audio/video files as a whole, independently of and prior to a query, and these pre-selected segments may be automatically retrieved and provided in audio/video thumbnails whenever their respective audio/video files are found responsive to a search or other user action. This may have an advantage in speed, and may be more consistently indicative of the audio/video files as a whole. Inherent indicative relevance of a given audio/video segment as an indicator of the general content of the audio/video file in which it is found may be evaluated by extracting any of a variety of indicative features from the segment, and predicting the relative importance of those features as indicators of the content of the files as a whole. Illustrative embodiments of such feature extraction and importance prediction are provided as follows.

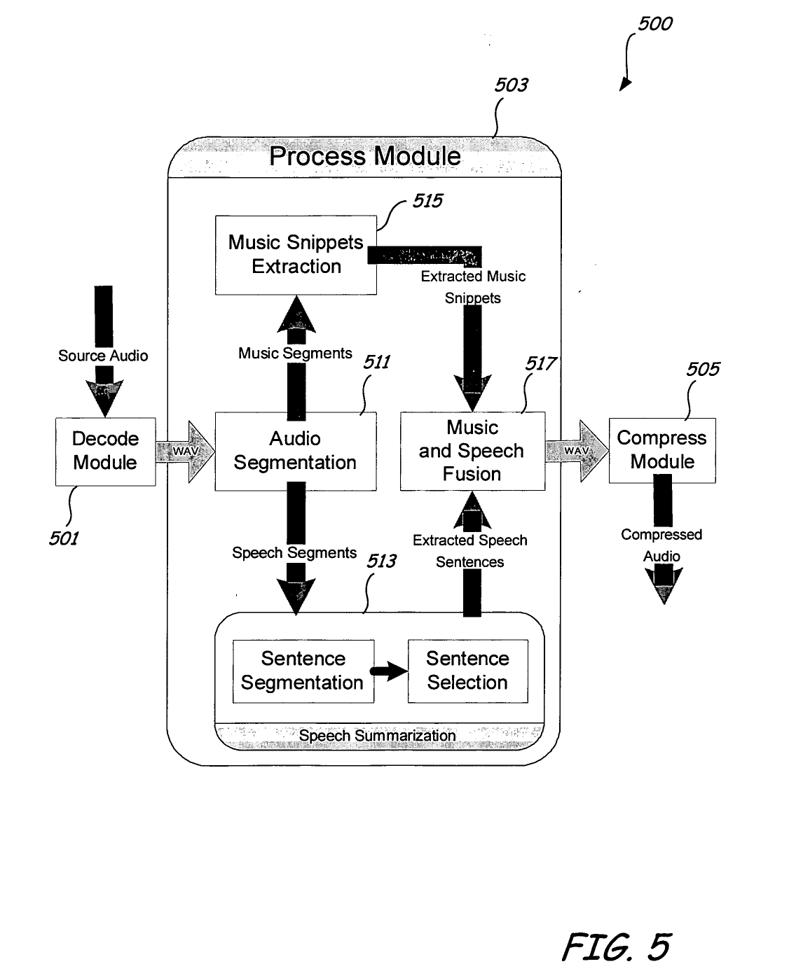

In one illustrative embodiment of an audio/video file summarization system 500, as depicted in the data flow module block diagram of FIG. 5, indicative features of audio/video segments may be evaluated by analyzing a number of features of both speech and music audio components, but without having to rely on automatic speech recognition. This illustrative embodiment includes decode module 501, process module 503, and compress module 505. Process module includes four sub-modules: audio segmentation sub-module 511, speech summarization sub-module 513, music snippets extraction sub-module 515, and music and speech fusion sub-module 517.

Source audio is first processed by decode module 501, the output of which is fed into audio segmentation sub-module 511, which separates the data into a music component and a speech component. The speech component is fed to speech summarization sub-module 513, which includes both a sentence segmentation sub-module 521 and a sentence selection sub-module 523. The music component is fed to music snippets extraction sub-module 515, which extracts snippets of music from longer passages of music. The resulting extracted speech segments and extracted music snippets are both fed to music and speech fusion sub-module 517, which combines the two and feeds it to compress module 505, to produce a compressed form of an indicative audio/video segment. In other embodiments, any or all of these modules, and others, may be used. Illustrative methods of operation of these modules is described as follows.

In this illustrative embodiment, audio segmentation sub-module 511 may separate music from speech by methods including mel frequency cepstrum coefficients, resulting from taking a Fourier transform of the decibel spectrum, with frequency bands on the mel scale; and including perceptual features, such as zero crossing rates, short time energy, sub-band powers distribution, brightness, bandwidth, spectrum flux, band periodicity, and noise frame ratio. Any combination of these and other features can be incorporated into a multi-class classification scheme for a support vector machine; experiments have been performed to indicate the characteristics of these classes in distinguishing between speech and music, as those skilled in the art will appreciate.

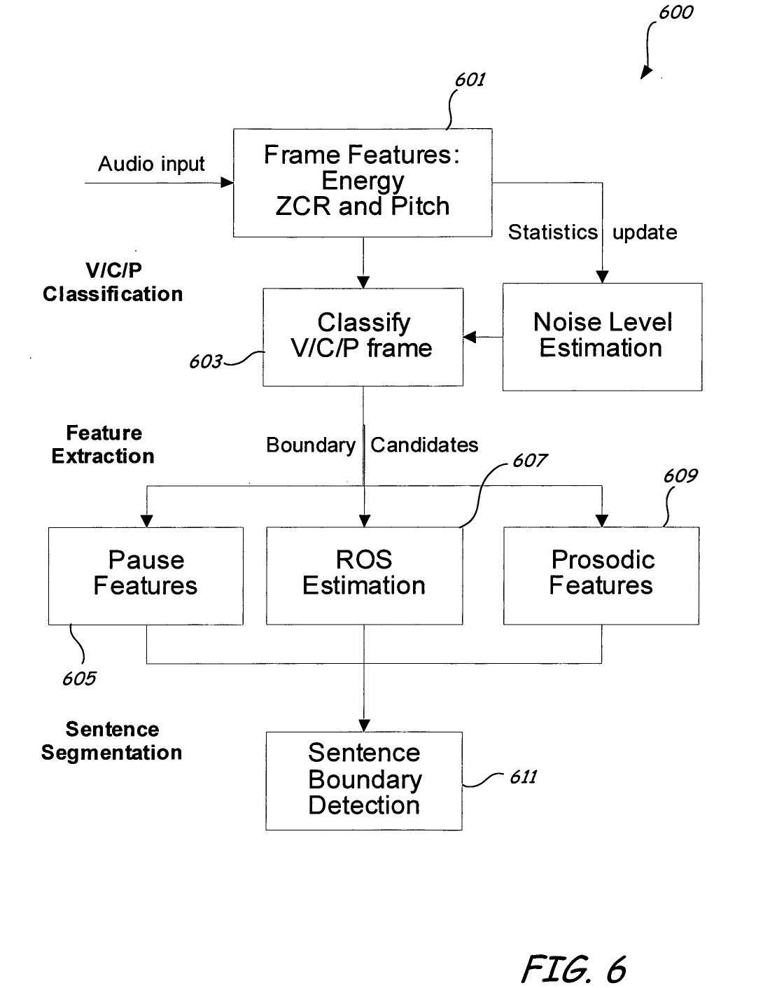

Speech summarization sub-module 513 may rely on analyzing prosodic features, in one illustrative embodiment that is described further as follows. Speech summarization sub-module 513 could use variations on these steps, or also use other methods such as automatic speech recognition, in other illustrative embodiments. Sentence segmentation is performed first, by sentence segmentation sub-module 521, as illustratively depicted in the flowchart 600 of FIG. 6. First, basic features are extracted. The input audio is segmented into 20 millisecond long non-overlapping frames, and frame features are calculated, such as frame energy, zero-crossing rate (ZCR), and pitch value. The frames are grouped into Voice, Consonant, and Pause (V/C/P) phoneme levels, with an adaptive background noise level detection algorithm. Long enough estimated pauses become candidates for sentence boundaries. Then, three feature sets are extracted, including pause features, rate of speech (ROS), and prosodic features, and combined to represent the context of the sentence boundary candidates. A statistical method is then used to detect the true sentence boundaries from the candidates based on the context features.

Sentence features are then extracted next in this illustrative embodiment, including prosodic features such as pitch-based features, energy-based features, and vowel-based features. For every sentence, an average pitch and average energy are determined. Additional features that can be determined include the minimum and maximum pitch per sentence; the range of pitch per sentence; the standard deviation of pitch per sentence; the maximum energy per sentence; the energy range per sentence; the standard deviation of energy per sentence; the rate of speech, determined by the number of vowels per sentence and the duration of the vowels; and the sentence length, normalized according to the rate of speech.

Once the features are extracted, the importance of the sentences may be predicted using linear regression analysis.

Music snippets extraction sub-module 515 extracts the most relevant music snippets, as indicated by those with frequent occurrence and high energy, in this illustrative embodiment. First, basic features are extracted, using mel frequency cepstral coefficients and octave-based spectral contrast. From these features, higher-level features can be extracted. Music segments are then evaluated for relevance based on occurrence frequency, energy, and positional weighting; and the boundaries of musical phrases are detected, based on estimated tempo and confidence of a frame being a phrase boundary. Indicative music snippets are then selected.

Once both the indicative speech samples and music snippets are selected, they can be joined together and optionally compressed, by music and speech fusion sub-module 517 and compress module 505. An audio/video segment is then ready for use.

The search query or other user action may be compared with video files in a number of ways. One way is to use text, such as transcripts of the video file, that are associated with the video file as metadata by the provider of the video file. Another way is to derive transcripts of the video or audio file through automatic speech recognition (ASR) of the audio content of the video or audio files. The ASR may be performed on the media files by computing devices 20 or 32, or by an intermediary ASR service provider. It may be done on an ongoing basis on recently released video files, with the transcripts then saved with an index to the associated video files. It may also be done on newly accessible video files as they are first made accessible.

Any of a wide variety of ASR methods may be used for this purpose, to support audio/video thumbnail search result systems 10 or 30. Because many video files are provided without metadata transcripts, the ASR-produced transcripts may help catch a lot of relevant search results that are not found relevant by searching metadata alone, where words from the search query appear in the ASR-produced transcript but not in the metadata, as is often the case.

As those skilled in the art will appreciate, a great variety of automatic speech recognition systems and other alternatives to indexing transcripts are available, and will become available, that may be used with different embodiments described herein. As an illustrative example, one automatic speech recognition system that can be used with an embodiment of a video search system uses generalized forms of transcripts called lattices. Lattices may convey several alternative interpretations of a spoken word sample, when alternative recognition candidates are found to have significant likelihood of correct speech recognition. With the ASR system producing a lattice representation of a spoken word sample, more sophisticated and flexible tools may then be used to interpret the ASR results, such as natural language processing tools that can rule out alternative recognition candidates from the ASR that don't make sense grammatically. The combination of ASR alternative candidate lattices and NLP tools thereby may provide more accurate transcript generation from a video file than ASR alone.

In addition to ASR, one illustrative embodiment distinguishes between audio components characteristic of spoken word and audio components characteristic of vocal music, and applies ASR to the spoken word audio components and a separate music analysis to the musical audio components. Although some of the analysis is in common, some is also distinctive between the two. For example, the ASR uses sentence segmentation and analysis, while the music analysis uses basic feature extraction, salient segment detection and music structure analysis. The information gleaned from both speech and music in comparison with their common timeframe can provide a more robust way of gleaning useful information from the audio components of audio/video files.

Concatenating the audio/video segments may take place in any of a variety of different methods. For example, in one illustrative embodiment, the selected audio/video segments are concatenated into a single audio/video file or a single audio/video data stream in the creation of the audio/video thumbnails. In another illustrative embodiment, the selected audio/video segments are concatenated into a series of separate but sequentially streamed files in a playlist, with switching time between the segments minimized. Such a playlist concatenation may be performed either by a server from which the segments are streamed, or in situ by a client device.

Audio/video thumbnails are capable of providing indicative information about audio/video files that other modes of indicating search results are not likely to duplicate; audio/video segments may logically be the most informative way of representing a sample of the content of audio/video files than non-audio/video formats such as text. In addition, audio/video thumbnails are ideal for the growing use of computing devices that are highly mobile and have little or no monitor. If a user performs a search and gets 20 results, but is in an environment where she cannot easily look at on-screen results, such as on a mobile phone or other mobile computing environment, or a music file player, the results are far more useful in the form of audio/video thumbnails.

Audio/video thumbnails are intended to provide a short audio and/or video summary, for example 15 to 30 seconds long per audio/video thumbnail in one illustrative embodiment, to give the user just enough to listen to or watch to get an idea of whether that audio/video file is what she is looking for. It is also easy to skip through different audio/video thumbnails, for those that make clear after only a fraction of their short duration that they do not refer to audio/video files the user is interested in. For example, by tapping the forward key 407 of computing device 400, the user can cut short the audio/video thumbnail she is presently watching and skip straight to the subsequent audio/video thumbnail. This can work in a number of different ways in different embodiments. For example, in one embodiment, the audio/video thumbnails are provided in a sequential queue of descending rank in relevance from the top down, one audio/video thumbnail after another as the default. The queue of audio/video thumbnails is interrupted only by a user actively making a selection to do so, and the queue plays until the user selects an option to engage playback of the audio/video file to which one of the audio/video thumbnails corresponds.

In another embodiment, the audio/video thumbnails are provided starting with a first audio/video thumbnail, such as the highest ranked thumbnail for relevance to the search; and by default, the audio/video thumbnail is followed by the audio/video file to which that audio/video thumbnail corresponds, which is automatically played after its thumbnail, unless the user selects an option to play another one of the audio/video thumbnails. For example, this mode may be more appropriate where the user is more confident that the search is narrowly tailored and the first result is likely to be the desired one or one of the desired ones, and the audio/video thumbnail played prior to it is primarily to confirm a prior expectation in a relevant first search result. This default play mode and the one discussed above just previous to it may also serve as user preferences that the user can set on his computing device.

Search results may also be cached, in association with the search query to which they were found relevant, so they are readily brought back up in case a search on the same search- query is later repeated. This avoids the need to repeatedly retrieve and concatenate the audio/video thumbnails in response to a popular search query, and advantageously enables results to the repeated search to be provided with little demand on the processing resources of the computing device.

Compressing the audio/video files and segments can also be a valuable tool for maximizing performance in providing audio/video thumbnails in response to a search. In one illustrative embodiment, the audio/video segments are evaluated in their decompressed form for their relevance to the search query, and the audio/video segments are then stored in a compressed form after being indexed for evaluation for later use. In this illustrative embodiment, when the audio/video segments are provided for being relevant to a search, the audio/video files corresponding to the audio/video segments are selected in the compressed form, and decompressed only if accessed by a user. In this embodiment, the audio/video segments are also retrieved in a compressed form from a compressed form of the audio/video files, and concatenated into the audio/video thumbnails in their compressed form. The audio/video thumbnails are decompressed prior to being provided via the user output.

When short audio/video segments are concatenated into a short audio/video thumbnail, the possibility exists that transitions between the segments can be jumpy and disorienting. In one illustrative embodiment, this potential issue is addressed by generating a brief video editing effect to serve as a transition cue between adjacent pairs of audio/video segments, within and between audio/video thumbnails. This editing effect can be anything that can serve as a transition cue in the perception of the user. A few illustrative examples are a cross-fade; an apparent motion of the old audio/video segment moving out and the new one moving in; showing the video in a smaller frame; showing an overlay text such as “summary” or “upcoming”; or adding a sample of background music, for example. The transition cues may be generated and provided during playback of the audio/video thumbnails, or they may be stored as part of the audio/video segments prior to concatenating the audio/video segments into the audio/video thumbnails, for example.

The distinction between the audio/video thumbnail and its corresponding audio/video file allows for the gap between the two to be filled by an unrelated audio/video segment, such as an advertisement. Presently, many online audio/video files are set up so that when a user selects the file to watch, an unrelated audio/video segment such as an advertisement is presented first, before the user has had any experience of the intended audio/video file. With the audio/video thumbnail provided first, the user can either come to know that the corresponding file is not something she is interested in, or can come to see that it is something she is interested in and perhaps become excited to see the full audio/video file.

Either way, the use of the audio/video thumbnail is advantageous. If the file is one the user determines she is not interested in, after watching only the short span or a fraction thereof of the audio/video thumbnail, she can disregard the full file, without the frustration of having sat through an advertisement first only to discover early into the main audio/video file that it is not something she is interested in.

On the other hand, if the main audio/video file is something the user is interested in seeing, he will already gain an appreciation to that effect after watching only the audio/video thumbnail, which can act as a teaser trailer for the full audio/video file, in this capacity. The user may then feel a lot more patient and good-natured with the intervening advertisement, already confident that the subsequent audio/video file is something he will appreciate and that it will be worth spending the time with the advertisement first. This might not only tilt viewers to perceive the advertisement with a more favorable state of mind, but, with many online advertisements paid by the click or per viewer, this serves a valuable advantage in screening those who do get to the point of clicking on the advertisement to be more likely to sit all the way through the advertisement and with a sharper state of attention.

A wide variety of methods may be used, in different embodiments, for selecting points to serve as beginning and ending boundaries for audio/video segments isolated from the surrounding content of the audio/video file. These may include video shot transitions; the appearance and disappearance of a human form occupying a stable position in the video image; transitions from silence to steady human speech and vice versa; the short but regular pauses or silences that mark spoken word sentence boundaries; etc. In general, audio transitions taken to correlate with sentence boundaries are more frequent than video transitions. By using both audio transition cues and video transition cues from the audio/video files to select beginning and ending boundaries defining the audio/video segments, a significant boost in accuracy of the audio/video segments conforming to real sentence breaks can be achieved over relying only on audio or video cues.

Speech recognition can add sophistication to evaluation of audio transitions, using clues from typical words that begin and end sentences or indicate that it is still in the middle of a sentence. Several features of candidate boundaries may be simultaneously evaluated, then a classifier used to judge which are true boundaries and which are not. Language model speech clues such as word trigram statistics can be used to recognize sentence boundaries.

In one illustrative embodiment, a search query on which the search is based can be saved and provided for a user-selectable automated search based on the search query. The updated or refreshed search may turn up one or more audio/video files that are newly selected in response to the new search, when a user selects to engage the automated search. As one exemplary implementation, a search incorporating a particular search query can be set up as a Web syndication feed, which may be specified in RSS, Atom, or another standard or format. In this example, each time the user engages the previously selected Web syndication feed, such as by opening a channel, hitting a bookmark, clicking a link, etc., the search is performed anew with the potential for a new set of search results.

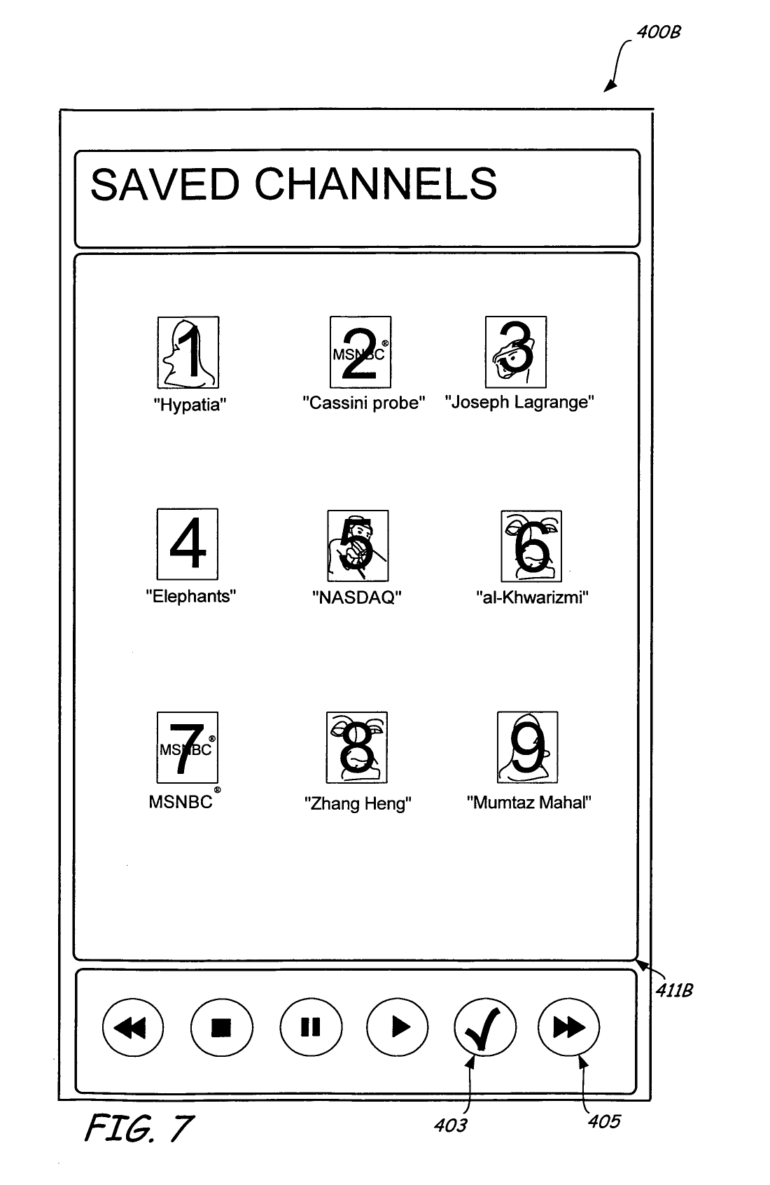

FIG. 7 depicts the search query of FIG. 4 being saved as a search channel, to join several at least that have already been stored on computing device 400B, as indicated on monitor 411B. With these search channels saved, the user has only to select one of the saved search channels and tap the enter key 403 to perform a new search on that search channel, with the search query as appearing in quotes for each of the search queries.

Once a search is saved, the search for audio/video files relevant to that search query is repeated, either by the user selecting that search again, or automatically and periodically, so that refreshed search results will already be ready to provide next time the user selects that search. The new, refreshed search potentially provides new search results that are added to the channel, or new weightings of different search results in the order in which they will be presented, as time goes on.

In one illustrative embodiment, related results, or results that are not identical but are related to keywords in the search query, are used as components of selecting and ranking search results, or when a related results search is selected by a user, keywords are extracted from a previously selected audio/video file and provided to the user. These are automatically extracted from an audio/video file currently or previously viewed by the user. Keywords may be selected among words that are repeated several times in the previously selected video file, words that appear in proximity a number of times to the original search query, words that are vocally emphasized by the speakers in the previously selected video file, unusual words or phrases, or that stand out due to other criteria. In another illustrative embodiment, instead of or in addition to explicitly extracting keywords from the video, other measures of similarity and/or relatedness may be compared, such as sets of words, non-speech elements such as laughter, applause, rapid camera motion, or any other detectable audio and video effects.

Keyword selection may also be based on more sophisticated natural language processing techniques. These may include, for example, latent semantic analysis, or tokenizing or chunking words into lexical items, as a couple illustrative examples. The surface forms of words may be reduced to their root word, and words and phrases may be associated with their more general concepts, enabling much greater effectiveness at finding lexical items that share similar meaning. The collection of concepts or lexical items in a video file may then be used to create a representation such as a vector of the entire file that may be compared with other files, by using a vector-space model, for example. This may result, for example, in a video file with many occurrences of the terms “share price” and “investment” being ranked as very similar to a video file with many occurrences of the terms “proxy statement” and “public offering”, even if few words appear literally the same in both video files. Any variety of natural language processing methods may be used in deriving such less obvious semantic similarities.

Different parts of a method for providing audio/video thumbnail search results may be performed by different computing devices under a cooperative arrangement. For example, an audio/video segmenting and thumbnail generating application may be downloaded from a computing services group by clients of the group. According to one illustrative embodiment, when the client performs a search, the services provider transmits the audio/video files to the client computing device along with an indication of the start and stop boundaries of the audio/video segments within the audio/video files. The client computing device then retrieves the audio/video segments from within the audio/video files according to the indications, and concatenates them into an audio/video thumbnail, before providing them via a local user output device to a user.

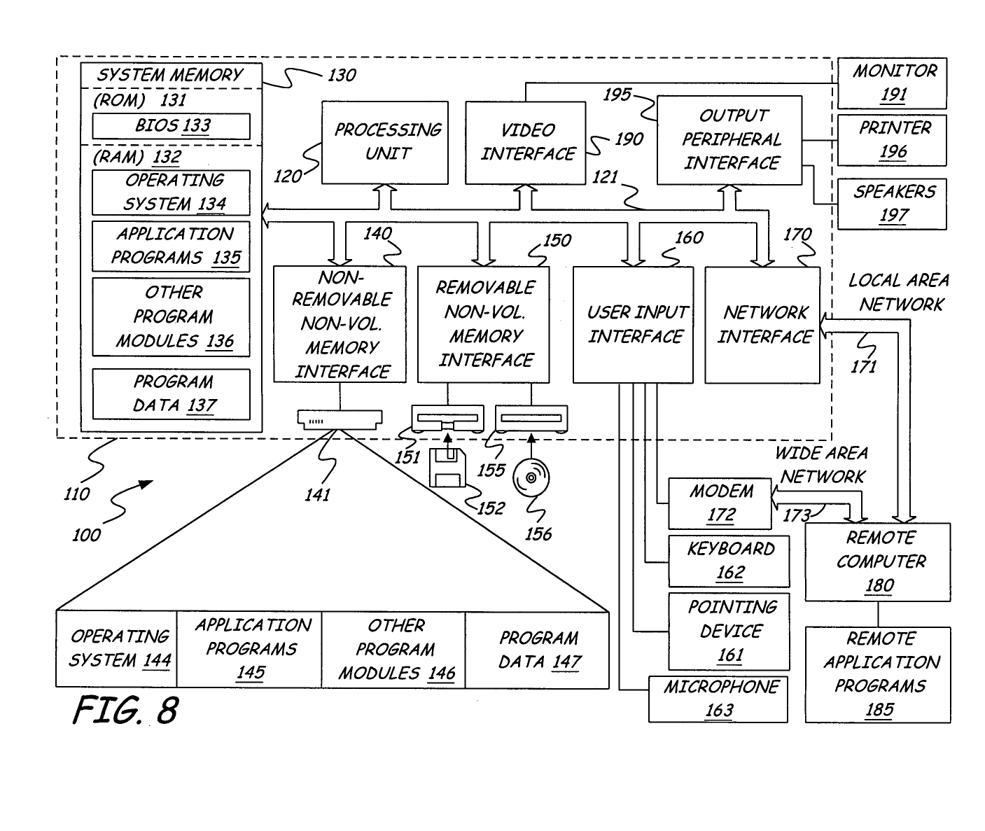

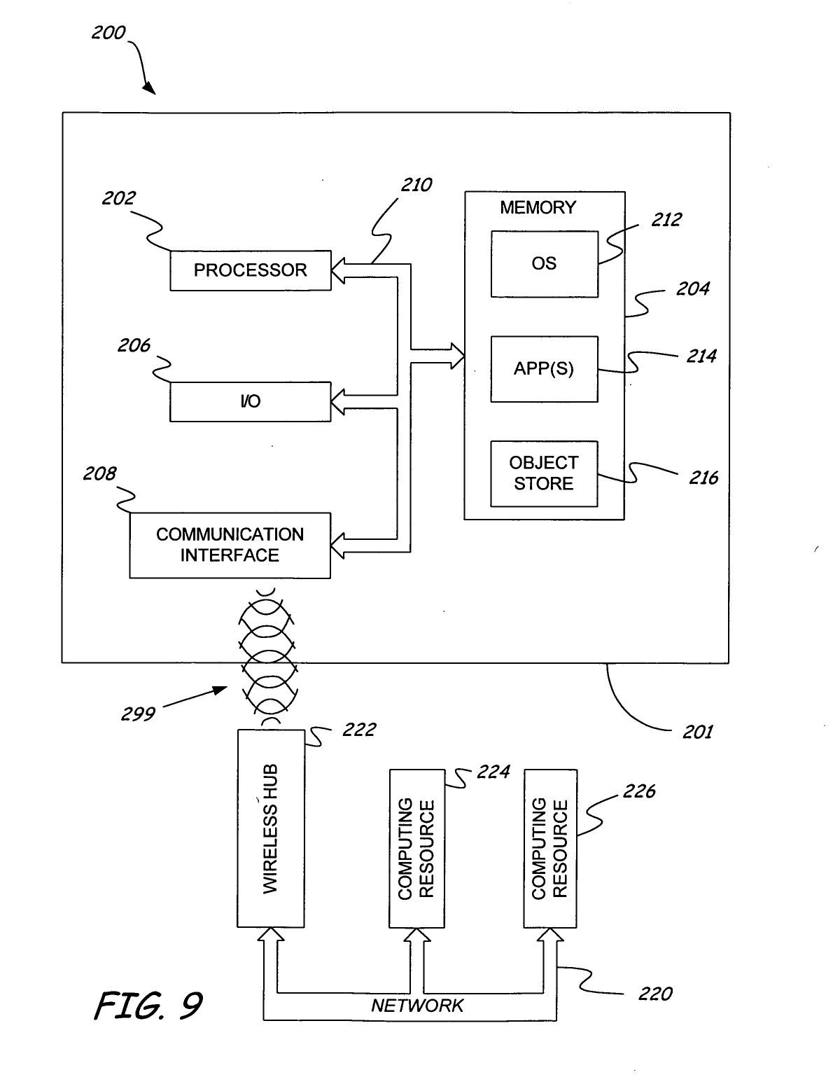

The capabilities and methods for the illustrative audio/video thumbnail search result systems 10 and 30 and method 300 may be encoded on a medium accessible to computing devices 12 and 32 in a wide variety of forms, such as a C# application, a media center plug-in, or an Ajax application, for example. A variety of additional implementations are also contemplated, and are not limited to those illustrative examples specifically discussed herein. Some additional embodiments for implementing a method of FIG. 3 are discussed below, with references to FIGS. 8 and 9.

Various embodiments may run on or be associated with a wide variety of hardware and computing environment elements and systems. A computer-readable medium may include computer-executable instructions that configure a computer to run applications, perform methods, and provide systems associated with different embodiments. Some illustrative features of exemplary embodiments such as are described above may be executed on computing devices such as computer 110 or mobile computing device 201, illustrative examples of which are depicted in FIGS. 8 and 9.

FIG. 8 depicts a block diagram of a general computing environment 100, comprising a computer 110 and various media such as system memory 130, nonvolatile magnetic disk 152, nonvolatile optical disk 156, and a medium of remote computer 180 hosting remote application programs 185, the various media being readable by the computer and comprising executable instructions that are executable by the computer, according to an illustrative embodiment. FIG. 8 illustrates an example of a suitable computing system environment 100 on which various embodiments may be implemented. The computing system environment 100 is only one example of a suitable computing environment and is not intended to suggest any limitation as to the scope of use or functionality of the claimed subject matter. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Various embodiments may be implemented as instructions that are executable by a computing device, which can be embodied on any form of computer readable media discussed below. Various additional embodiments may be implemented as data structures or databases that may be accessed by various computing devices, and that may influence the function of such computing devices. Some embodiments are designed to be practiced in distributed computing environments where tasks are performed by remote processing devices that are linked through a communications network. In a distributed computing environment, program modules may be located in both local and remote computer storage media including memory storage devices.

With reference to FIG. 8, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 8 illustrates operating system 134, application programs 135, other program modules 136, and program data 137.

The computer 110 may also include other removable/non-removable volatile/nonvolatile computer storage media. By way of example only, FIG. 8 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 8, provide storage of computer readable instructions, data structures, program modules and other data for the computer 110. In FIG. 8, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may be operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 8 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 8 illustrates remote application programs 185 as residing on remote computer 180. It will be appreciated that the network connections shown are exemplary and other means of establishing a communications link between the computers may be used.

FIG. 9 depicts a block diagram of a general mobile computing environment, comprising a mobile computing device and a medium, readable by the mobile computing device and comprising executable instructions that are executable by the mobile computing device, according to another illustrative embodiment. FIG. 9 depicts a block diagram of a mobile computing system 200 including mobile device 201, according to an illustrative embodiment. Mobile device 200 includes a microprocessor 202, memory 204, input/output (I/O) components 206, and a communication interface 208 for communicating with remote computers or other mobile devices. In one embodiment, the afore-mentioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is illustratively allocated as addressable memory for program execution, while another portion of memory 204 is illustratively used for storage, such as to simulate storage on a disk drive.

Memory 204 includes an operating system 212, application programs 214 as well as an object store 216. During operation, operating system 212 is illustratively executed by processor 202 from memory 204. Operating system 212, in one illustrative embodiment, is a WINDOWS® CE brand operating system commercially available from Microsoft Corporation. Operating system 212 is illustratively designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200.

Mobile computing system 200 also includes network 220. Mobile computing device 201 is illustratively in wireless communication with network 220—which may be the Internet, a wide area network, or a local area network, for example—by sending and receiving electromagnetic signals 299 of a suitable protocol between communication interface 208 and wireless interface 222. Wireless interface 222 may be a wireless hub or cellular antenna, for example, or any other signal interface. Wireless interface 222 in turn provides access via network 220 to a wide array of additional computing resources, illustratively represented by computing resources 224 and 226. Naturally, any number of computing devices in any locations may be in communicative connection with network 220. Computing device 201 is enabled to make use of executable instructions stored on the media of memory component 204, such as executable instructions that enable computing device 201 to provide search results including audio/video thumbnails.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, implemented by a computing device, comprising:
selecting one or more audio/video files having relevance to a user input;
retrieving one or more audio/video segments from each of one or more of the audio/video files; and
providing the audio/video segments via a user output.

2. The method of claim 1, wherein the user input comprises a query search, and wherein the audio/video files are selected and ranked based on relevance of the audio/video files to one or more keywords in a search query on which the query search is based.

3. The method of claim 1, wherein the user input comprises a similar content search based on previously accessed content, and wherein the audio/video files are selected and ranked based on relevance of the audio/video files to the previously accessed content on which the similar content search is based.

4. The method of claim 1, wherein an automatic recommendation mode is engaged, and wherein the audio/video files are selected and ranked based on relevance of the audio/video files to the user input, and are provided as an automatic recommendation to the user.

5. The method of claim 1, wherein the audio/video segments retrieved are selected from the audio/video files based on relevance of the audio/video segments as indicative of the content of the audio/video files.

6. The method of claim 1, further comprising generating text from the audio/video files using automatic speech recognition to evaluate the relevance of the audio/video files to the user input.

7. The method of claim 1, wherein the audio/video segments are pre-selected from the audio/video files prior to the user input, such that the audio/video segments retrieved from each of the audio/video files selected comprise the pre-selected audio/video segments for the selected audio/video files.

8. The method of claim 1, wherein the audio/video files are retrieved in a compressed form, and the audio/video segments are provided in an uncompressed form.

9. The method of claim 1, wherein two or more of the audio/video segments are retrieved from each of the audio/video files and concatenated into an audio/video thumbnail corresponding to each of the audio/video files, and the audio/video segments are provided via the user output in the form of the audio/video thumbnails.

10. The method of claim 9, further comprising providing one of the audio/video thumbnails after another, until a user selects an option to engage playback of an audio/video file to which one of the audio/video thumbnails corresponds.

11. The method of claim 9, wherein one or more of the concatenated audio/video thumbnails are cached in association with the user input to which they were found to have relevance.

12. The method of claim 9, wherein one or more of the audio/video files to which one of the audio/video thumbnails corresponds is automatically played after the corresponding audio/video thumbnail, unless a user selects an option to play another one of the audio/video thumbnails.

13. The method of claim 9, wherein the audio/video segments are retrieved in a compressed form from a compressed form of the audio/video files, and concatenated into the audio/video thumbnails in the compressed form, wherein the audio/video thumbnails are decompressed prior to being provided via the user output.

14. The method of claim 13, wherein the audio/video segments in the decompressed form are used to evaluate the relevance of the audio/video segments to the user input, and the audio/video files corresponding to the relevant audio/video segments are retrieved in the compressed form, and decompressed only if accessed by a user.

15. The method of claim 9, further comprising generating a transition cue between each adjacent pair of the audio/video segments in the audio/video thumbnails.

16. The method of claim 9, wherein an audio/video segment of unrelated content is provided via the user output between the audio/video thumbnail and the audio/video file to which the audio/video thumbnail corresponds.

17. The method of claim 1, wherein both audio transition cues and video transition cues from the audio/video files are used to select beginning and ending boundaries defining the audio/video segments.

18. The method of claim 1, wherein the user input is saved and provided for a user-selectable automated search based on the user input, and one or more audio/video files are newly selected in response to a new search based on the user input when the automated search is selected by a user.

19. A means, implemented by a computing device, for:
receiving one or more search terms for a search of audio and/or video content;
performing a search for audio and/or video content relevant to the search terms;
isolating two or more audio and/or video segments from the audio and/or video content relevant to the search terms;
playing the audio and/or video segments; and
providing a user-selectable option to play a larger portion of the audio and/or video content from which a selected one of the audio and/or video segments was isolated.

20. A medium comprising instructions executable by a computing system, wherein the instructions configure the computing system to:
receive a search query for a search of audio/video files;
select one or more of the audio/video files for relevance to the search query;
retrieve two or more audio/video segments from each of one or more of the audio/video files;
concatenate the audio/video segments from each of the audio/video files from which the audio/video segments were retrieved into an audio/video thumbnail corresponding to the respective audio/video file; and
provide the audio/video thumbnails via a user output as results for the search.
